(19) United States
(12) Patent Application Publication
(10) Pub. No.: US 2009/0267018 A1
(43) Pub. Date: Oct. 29, 2009

(54) Refrigerant Composition

(76) Inventors: Seijyuro Maiya, Tokyo (JP); Osamu Nakagome, Tokyo (JP); Hideyuki Suzuki, Kanagawa (JP); Yasuhisa Kotani, Tokyo (JP); Toshifumi Hatanaka, Nara (JP); Toshihiro Wada, Chiba (JP)

Correspondence Address: THOMPSON COBURN LLP, ONE US BANK PLAZA, SUITE 3500, ST LOUIS, MO, 63101, US

(21) Appl. No.: 12/094,400

(22) PCT Filed: Aug. 16, 2006
(86) PCT No.: PCT/JP2006/316087

§ 371 Date: May 20, 2008

(30) Foreign Application Priority Data
Nov. 25, 2005 (JP) 2005-339840

(51) Int. Cl. C09K 5/04

(52) U.S. Cl. 252/67

(57) ABSTRACT

Problems

To provide a refrigerant that is ozone-friendly, exhibiting a very low global warning potential, and that is safe and nontoxic, ensuring high performance, by mixing dimethyl ether with carbon dioxide.

Means for Solving Problems

There is provided a refrigerant composition for a refrigerator, comprising 10-40% by mole of dimethyl ether and 90-60% by mole of carbon dioxide on the basis of a total number of moles of dimethyl ether and carbon dioxide.

### TECHNICAL FIELD

The present invention relates to a refrigerant composition containing dimethyl ether and carbon dioxide used for an automotive air conditioner, a heat pomp for a vending machine, industrial/household air conditioners, and the like.

### BACKGROUND ART

Freons (CFC chlorofluorocarbon, HCFC hydrochlorofluorocarbon) have been used as a refrigerant for an automotive air conditioner and the like in all over the world so far, since Freons have excellent refrigerant performance. However, currently, since Freon depletes the ozone layer because of containing chlorine, developed countries including Japan, Europe and the United States completely abolished production of CFC among specific Freons in 1996. Production of HCFC (hydrochlorofluorocarbon), which is the same specific Freon, was also regulated sequentially after 2004, and is planned to be completely abolished in Europe until 2010, and also in other developed countries until 2020.

Alternative Freons (HFC hydrofluorocarbon, PFC perfluorocarbon, and SP6) to the above described specific Freons have zero ozone-depleting potential, low toxicity, incombustibility, satisfactory characteristics and performances, but have problems such as incompatibility with mineral oil and deterioration of lubricity. Particularly, these alternative Freons do not deplete the ozone layer, but have extremely high global warming potential, and thus their use will be completely abolished or largely regulated in the near future, although there is no specific regulation at present and their regulation depends on self-imposed effort by the industry.

Natural refrigerants whose development has recently proceeded, such as carbon dioxide, ammonium, water and air, have characteristics such as zero ozone-depleting potential and almost zero global worming potential; however, they respectively have problems in terms of safety, performance, and convenience. Ammonium has efficiency equivalent to HFC, but it has toxicity, pungent odor, and incompatibility with copper. Water and air are incombustibility and non-toxic, but have extremely low efficiency.

On the other hand, since carbon dioxide has incombustibility and low toxicity, and large sensible heat effect, it has been recently used as an EHP refrigerant for Ecocute and the like for heating and hot water supply. However, carbon dioxide, on the contrary, has small latent heat effect, and thus efficiency thereof is extremely low when used for cooling. Further, when carbon dioxide is used as a refrigerant for an automotive air conditioner, a working pressure in a condenser side of the automotive air conditioner attains the superficial point (CO₂ critical pressure: 7.4 MPa, critical temperature: 31° C.) at a high pressure of 8 MPa or more, and in order to liquefy this high pressure gas phase refrigerant by the condenser, it is necessary to set the temperature of the refrigerant at 31° C. or less, as shown in the Mollier diagram of CO₂. However, in summer when an automotive air conditioner and the like are used the most, an outside temperature often exceeds 31° C. Under such an outside temperature condition, since a refrigerant containing carbon dioxide alone is not at all liquefied (condensed) in a condenser, heat release due to condensation cannot occur. That is, only cooling effect due to adiabatic expansion along with a decrease in pressure can be obtained, but no cooling effect due to heat of vaporization can be obtained. Therefore, a cooling cycle has a superficial pressure varying between a sub-critical pressure and the superficial pressure, a coefficient of performance (COP) under cooling conditions is low, and a working pressure of the compressor is extremely high.

In order to prevent this, particular devices are required; for example, water is circulated around a condenser of an automotive air conditioner, a condenser is cooled by rotating with a specific gas for a refrigerator, or a temperature of outside air taken in from a gas cooler is decreased to a temperature sufficiently capable of performing heat exchange. However, if these devices are provided, it is disadvantageous in view of cost.

On the other hand, it has been known that dimethyl ether (DME) has extremely high latent heat effect, and thus is advantageously used for cooling, but since dimethyl ether is flammable, it is not practically used for the safety reason.

### DISCLOSURE OF THE INVENTION

An object of the present invention is to provide a refrigerant composition for a refrigerator, which has no risk of depleting the ozone layer, small damaging effect on the global worming, is non-toxic, and exhibits excellent cooling performance.

The inventors of the present invention have found that carbon dioxide is dissolved well in dimethyl ether and that a mixed refrigerant of dimethyl ether and carbon dioxide can be used for hot water supply and heating, and describe inventions relating to novel refrigerants comprising a mixed gas of carbon dioxide and dimethyl ether in Japanese Patent Application No. 2004-167210 (filing date of Jun. 4, 2004) and Japanese Patent Application No. 2005-55957 (filing date of Mar. 1, 2005, priority date of Jun. 4, 2004, one other application), respectively. In the present invention, the inventors considered that utilizing the fact that the boiling point of dimethyl ether is −25° C. while the boiling point of carbon dioxide is −78.45° C., a decrease of vapor pressure is promoted by mixing dimethyl ether with carbon dioxide, and condensation (liquefaction) in a condenser can proceed, thereby construction of vapor compression cycle (condensation cycle) under the cooling conditions may be possible, and variously studies, and consequently attained to the present invention.

That is, the present invention relates to a refrigerant composition for a refrigerator comprising 10-40% by mole of dimethyl ether and 90-60% by mole of carbon dioxide on the basis of a total number of moles of dimethyl ether and carbon dioxide. Accordingly, the present invention can provide a refrigerant, which does not deplete the ozone layer, has an extremely small global warming potential (GWP of about 3), is non-toxic, and exhibits excellent cooling performance. Further, by using the refrigerant composition of the present invention for an automotive air conditioner and the like, construction of a vapor compression cycle (condensation cycle) under cooling conditions becomes possible, higher COP can be obtained as compared with a refrigerant containing carbon dioxide alone, and at the same time, a working pressure of a compressor can be deceased, which results in exhibiting an advantageous effect such that a specific device for cooling periphery of a condenser, or such as a gas cooler is not necessary, as is necessary for the carbon dioxide refrigerant alone.

### BRIEF DESCRIPTION OF THE DRAWINGS

FIG. 1 is Refrigerant cycle system for an automotive air conditioner.

FIG. 2 is DME CO₂ B program flow-chart.

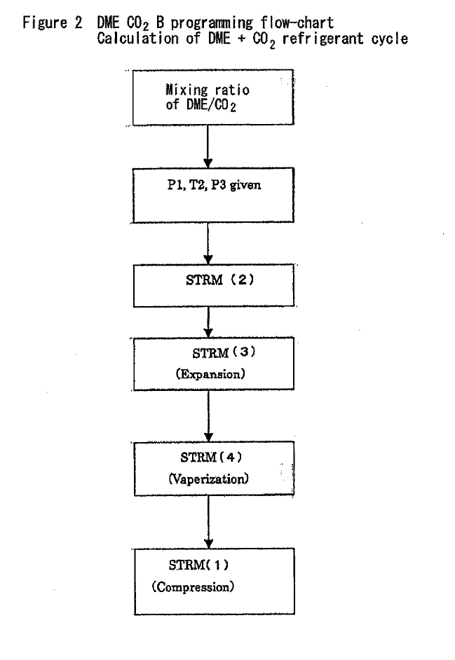

### BEST MODE FOR CARRYING OUT THE INVENTION

Preferred embodiments of the present invention will be explained in detail hereinbelow.

Dimethyl ether used in the refrigerant composition of the present invention can be obtained by synthesizing dimethyl ether directly from hydrogen and carbon monoxide or indirectly from hydrogen and carbon monoxide through methanol synthesis by utilizing, as raw material, a coal gasification gas, a BOG (boil of gas) of LNG tank, natural gases, by-product gases from a steel plant, oil residues, waste products and biogas.

Carbon dioxide used in the refrigerant composition of the present invention can be obtained by compression, liquefaction and purification of ammonium synthesis gas and by-product gas as the raw material generated from hydrogen manufacturing plant for desulfurization of fuel oil.

A mixing ratio of dimethyl ether and carbon dioxide in the refrigerant composition of the present invention is appropriately determined depending on types of an automotive air conditioner and a refrigerator such as a refrigerator for a vending machine, and the like, in which a refrigerant is used. The refrigerant composition of the present invention contains, on the basis of the total number of moles of dimethyl ether and carbon dioxide, preferably dimethyl ether at 10-40% by moles and carbon dioxide at 90-60% by moles. If a ratio of dimethyl ether is less than 10% by moles, a sufficient coefficient of the performance hereinafter described is not obtained, and characteristics as a refrigerant are inferior. On the other hand, if the ratio of dimethyl ether is more than 40% by moles, since the refrigerant composition is out of a nonflammable range, it is unfavorable on safety reason.

The refrigerant composition of the mixed ratio of the present invention can be obtained, for example, when used in an automotive air conditioner, by filling a predetermined amount of liquid dimethyl ether in arsuitable vessel such as a service can depending on its volume from a tank filled with liquid dimethyl ether, subsequently filling a predetermined amount of liquid carbon dioxide thereto from a tank filled with liquid carbon dioxide. Further, after filling the predetermined amount of liquid dimethyl ether in the suitable vessel such as a service can depending on the volume of the automotive air conditioner, the refrigerant composition of the present invention can be prepared by such that carbon dioxide gas is filled into the gas phase part of the vessel and is dissolved and mixed under pressure into dimethyl ether.

The refrigerant composition of the present invention may be composed only of dimethyl ether and carbon dioxide, or may contain other components in addition to the mixed medium. Examples of other components which can be added to the refrigerant composition of the present invention include alcohols such as ethanol.

The principle of a cooling system is based on continuous heat exchange between latent heat that draws heat energy from a peripheral medium and the peripheral medium when a substance (refrigerant) is vaporized. An evaporation temperature of the refrigerant depends on a pressure, if the pressure is decreased, the evaporation temperature also decreases, and thus, a lower temperature can be attained.

On the other hand, the principle of a heating and hot water supply system can be achieved by performing continuous heat exchange with water, air, or the like by drawing heat from periphery of a refrigerant due to evaporation to form a further compressed liquid with a high temperature.

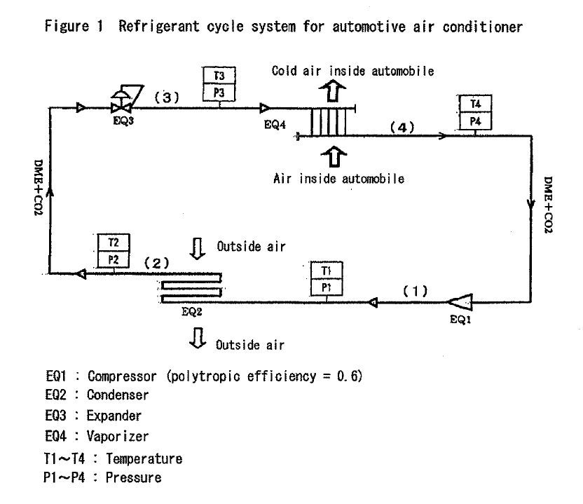

A system for an automotive air conditioning is also based on these principles of the cooling/heating system, which is a refrigerant cycle system composed of a compressor, a condenser, an expander and a vaporizer. As an example of the refrigerant cycle system in which the refrigerant composition of the present invention is used, a non-limiting example of a refrigerant cycle system for an automotive air conditioner is shown in FIG. 1. Herein, in cooling conditioning, a refrigerant highly compressed and increased in temperature in a compressor is cooled with external air in a condenser to be a liquid phase. This liquid phase refrigerant is evaporated in a vaporizer via endothermic exchange with air in an automobile to cool the inside of the automobile.

Functions of respective equipments in FIG. 1 are described as follows.
EQ1 Compressor: a cool refrigerant to be a gas in a vaporizer is vacuum-compressed to be a high-temperature and high-pressure gas.
EQ2 Condenser: the high-temperature and high-pressure gas medium discharged from the compressor is cooled with water or air (external air) and condensed to be a liquid (for heating/hot water supply).
EQ3 Expander: the high-temperature and high-pressure liquid refrigerant is expanded to be a low-temperature and low-pressure refrigerant.
EQ4 Vaporizer: the low-temperature and low-pressure refrigerant is brought into contact with peripheral gas around an outlet of the expander to remove heat thereof, and evaporated and vaporized to be a gas (for cooling).

In order to evaluate actual cooling performance of a refrigerant, a numerical model of the above described refrigerant cycle is prepared, and using the general-purpose simulation system for a numerical chemical process, the cooling performance of the refrigerant can be analyzed and evaluated by the known method (e.g. see Miyara, Akio et al., “Effect of heat transfer characteristics of heat exchanger on non-azeotropic mixture refrigerant heat pump cycle,” Transactions of the Japanese Association of Refrigeration, 7(1): 65-73, 1990). The general-purpose simulation system for the numerical chemical process stores database of thermodynamic properties of various components, and equilibrium thermodynamic calculation on the interaction of chemical components corresponding to a mechanical engineering function of various systems can be performed.

In the numerical simulation, a system circulating the refrigerant composed of a compressor, a circulator, an expander and a vaporizer is expressed numerically, and the cooling/heating/hot water supply performance is evaluated as a coefficient of performance (COP) by using parameters of outlet pressure of compressor (P1) (hereinafter, abbreviated as “compressor pressure,” or “discharge pressure”), outlet temperature of a condenser (T2), temperature of a vaporizer (T3) and concentration of a refrigerant composition component.

Cooling COP=total amount of heat absorption of refrigerant in vaporizer/amount of power of compressor

Heating/hot water supply COP total amount of exhaust heat of refrigerant in condenser/amount of power of compressor

The present invention can be highly precisely evaluated by applying, preferably as an estimate equation for thermodynamic physical value of refrigerant, regular solution model with respect to dissolution and SRK (Soave-Redlich-Kwong) equation of state with respect to the equation of state, respectively.

Further, physical factors concerning with condensation of a refrigerant are discharge pressure (pressure of a compressor), outlet temperature of a condenser, a mixing ratio of carbon dioxide and dimethyl ether, temperature of peripheral external temperature, and critical temperature retained by a refrigerant. These physical factors are assigned into the above-described SRK state equation to perform numerical simulation, and a condensation ratio (presence or absence of condensation) can be also found.

Herein, as the condition in which the condensation cycle can be formed, it is required that a discharge pressure is a threshold value or more, and a peripheral external temperature is lower than a critical temperature of the refrigerant and an outlet temperature of a condenser. However, the discharge pressure varies depending on a mixing ratio of carbon dioxide and dimethyl ether.

Examples of a refrigerator in which the refrigerant composition of the present invention can be preferably used include an automotive air conditioner, a heat pump for a vending machine, an air conditioner for institutional use and home use, and gas heat pump (GHP) and an electrical heat pump (EHP), but are not limited to these examples. The refrigerant composition of the present invention can be used as it is, is principle, in an automotive air conditioner, a heat pump for a vending machine, an air conditioner for institutional use and home use, GHP and EHP, etc. in which conventional refrigerants such as R22 are used. However, in consideration of physical properties of the refrigerant composition of the present invention, it is further desirable that a mechanical aspect of a condenser, a piston, etc. are improved and designed in conforming of the refrigerant composition of the present invention.

### EXAMPLES

The present invention will be described with reference to examples hereinbelow in detail, however the present invention is not limited within these examples.

### Solubility Test of Dimethyl Ether/Carbon Dioxide

In order to know solubility of a mixture system of dimethyl ether (DME) and carbon dioxide (CO₂), and in order to obtain coefficient of performance of the mixed refrigerant in the refrigerant cycle system described hereinbelow, a solubility test of DME/CO₂ was performed. The test method is as follows.

(1) 300 g of dimethyl ether was encapsulated and sealed in a 500-mL pressure vessel, and weight of the sealed vessel was measured by using electric weighing machine.
(2) The pressure vessel was set in the constant-temperature bath and kept at a constant temperature.
(3) Carbon dioxide was injected by using a booster pump until obtaining a constant pressure.
(4) Weight of the filled carbon dioxide was calculated by weighing before and after filling (d=0.1 g).

In the filling, the pressure vessel was shaken up and down for completely mixing DME/CO₂, and the test was performed after allowing to stand vertically.

Results obtained are shown in Table 1. As shown in Table 1, a value of K-volume of CO₂ and DME is within the range of 0.66<KDME<0.80 and 2.59<KCO₂<3.42, respectively, including good solubility of carbon dioxide in DME.

TABLE 1
Solubility test results of DME/CO₂

Case

| | A | B | C | D |
|---|---|---|---|---|
| Pressure of system | 10.0 | 10.0 | 10.0 | 1.0 |
| Temperature of | 10 | 20 | 30 | 40 |
| system (° C.) | | | | |
| ZCO₂ (g-mol) | 1.682 | 1.500 | 0.977 | 1.045 |
| ZDME (g-mol) | 6.522 | 6.522 | 6.522 | 6.522 |
| V (g-mol) | 1.177 | 1.378 | 2.090 | 0.661 |
| L (g-mol) | 7.027 | 6.634 | 5.409 | 6.906 |
| YCO₂ (mol %) | 43.2 | 42.9 | 26.3 | 39.0 |
| XCO₂ (mol %) | 16.7 | 13.7 | 7.9 | 11.4 |
| KCO₂ (—) | 2.59 | 3.13 | 3.33 | 3.42 |
| YDME (mol %) | 56.8 | 57.1 | 73.7 | 61.0 |
| XDME (mol %) | 83.7 | 86.3 | 92.1 | 88.6 |
| KDME | 0.68 | 0.66 | 0.80 | 0.69 |

ZCO₂ = V * YCO₂ + L * CO₂
ZCO₂ + ZDME = V + L
KCO₂ = YCO₂/XCO₂
KDME = YDME/XDME

### First Example

Coefficient of performance (COP) of the mixed refrigerant of dimethyl ether and carbon dioxide in the refrigerant cycle system shown in FIG. 1 was obtained. Simulation using the simulation system for the numerical chemical process was performed by following operation procedure.

### Simulation Procedure

A quantity of state of stream (1) to (4) (volume, enthalpy, entropy, etc.) in the refrigerant cycle system in FIG. 1 was determined by simulation to obtain coefficient of performance (COP) of the following equation.

COP=H1/H2

H1: total amount of exhaust heat of refrigerant in condenser

H2: amount of power of compressor from (4) to (1)

Condition setting was as follows.

(1) CO₂/DME mixed Refrigerant

In order to evaluate hot water supply ability of a CO₂/DME mixed refrigerant, the discharge pressure of the compressor, the pressure of the vaporizer and the mixing ratio of CO₂/DME were used as fluctuating parameter for calculation.

P1=3.7 MPa to 6.8 MPa

P3=1.05 MPa to 2.6 MPa

Refrigerant vaporization temperature: around 8° C.

Mixing ratio of DME/CO₂ (10/90, 12/88, 15/85, 20/80, 30/70:molar ratio)

### (2) Refrigerant of CO₂ Alone

For a refrigerant of carbon dioxide alone, it is necessary that an outlet temperature T2 of the condenser is decreased to 31° C. or less in this cooling cycle, the heating source for the condenser of an automotive air conditioner is outside air, and in the case where a temperature of the outside air is 31° C. or more, the above described condensation cycle is not established. Therefore, this simulation was not performed.

### Estimation of Gas-Liquid Physical Properties of DME+CO₂ Mixed System

In the simulation study, the accuracy of the employed estimation model for physical properties is an important factor and a trial examination was performed as follows.

In general, a gas-liquid equilibrium relation is expressed in the following equation.

φᵢPyᵢ=fᵢ⁽⁰⁾γᵢ⁽⁰⁾xᵢ×exp∫₀^{P} V̅ᵢ^{L}/RT_{dp}

φi: Gas phase Fugacity Coeff.

### P: System Pressure

yi: Gas phase molar fraction
fᵢ⁽⁰⁾: Liquid phase standard Fugacity
γᵢ⁽⁰⁾: Activity coefficient of liquid phase
xᵢ: Liquid phase molar fraction
exp∫₀^{P} V̅ᵢ^{L}/RT_{dp}: Poynting Facter Points to be considered are following three points.

(1) γᵢ⁽⁰⁾ model for DME

(2) Degree of relative volatility of DME and CO₂

(3) Enthalpy and entropy model

Although DME is an oxygen containing low molecular weight compound, since the boiling point of the representative substance, ethanol, is 78° C., whereas that of DME is −25° C., it can be understood that it has no strong polarity as compared with alcohol, aldehyde and ketone groups. Consequently, a regular dissolution model can be applied for γᵢ⁽⁰⁾ of DME.

As obtained from DME/CO₂ solubility test data (Table 1), values of K-volume of DME and CO₂ are within the range of 0.66<KDME<0.80 and 2.59<KCO₂<3.42, respectively, including that there is no large difference in volatility between DME and CO₂. Consequently, a vapor pressure model can be applied for fᵢ⁽⁰⁾.

Since the estimated maximum pressure for use in DME+CO₂ system with regard to enthalpy and entropy is approximately 10 MPa, SRK (Soave-Redlich-Kwong) equation of state can preferably be employed.

$$P = \frac{RT}{v - b} - \frac{{a [ 1 + ( 0.48 + 1.574 w - 0.176 {w}^{2} ) {( 1 - Tr )}^{1 / 2} ]}^{2}}{{v}^{2} + bv}$$

γᵢ⁽⁰⁾: Regular Solution Model
fᵢ⁽⁰⁾: Vaper Pressure Model
φi, H, S SRK equation of State

### Poynting Facter: Considered

When pressure of the system becomes high in some degree (several MPa), Poynting factor cannot be negligible, consequently this point was taken into consideration.

### Program

The following two programs, A and B were used.

### (1) DME CO₂ A

Flash calculation under given composition, T (temperature) and P (pressure).

A bubble point was calculated under the given composition and P1 (compressor pressure).

According to this condition, confirmation for an accuracy of gas-liquid equilibrium physical property estimation model and whether total condensation in the condenser can be in sight.

### (2) DME CO₂ B

Using the above explained simulator, COP of the refrigerant composition containing dimethyl ether and carbon dioxide was obtained as follows.

### Example 1

In order to evaluate cooling ability of a dimethyl ether/carbon dioxide mixed refrigerant, the discharge pressure (P1) of the compressor, the outlet temperature (T2) of the condenser, the pressure (P3) of the vaporizer and the mixing ratio of DME/CO₂ were used as fluctuating parameter for calculation to perform a simulation. Herein, an outlet temperature T2 of the condenser was set at 35° C., and a temperature of the vaporizer was set at 4-5° C. on average. Mixing weight ratios of DME/CO₂ with which the simulation was performed are shown in Table 2. Simulation results of cooling characteristics of refrigerant compositions in the mixing ratios are shown in Table 3.

TABLE 2
Mixing weight ratios of DME/CO₂

Experiments

| | 1 | 2 | 3 | 4 | 5 | 6 |
|---|---|---|---|---|---|---|
| CO₂ | 90 | 88 | 85 | 80 | 70 | 60 |
| DME | 10 | 12 | 15 | 20 | 30 | 40 |

TABLE 3
Cooling characteristics of DME/CO₂ mixed refrigerant composition

| Weight ratios of mixing | | | | Vaporizer | | | |
|---|---|---|---|---|---|---|---|
| refrigerants (% by mole) | | Compressor | | | Inlet | Outlet | |
| CO₂ | | Pressure | Temperature | Pressure | temperature | temperature | |
| (%) | DME (%) | (MPa) | (° C.) | (MPa) | (° C.) | (° C.) | COP |
| 90 (90) | 10 (10) | 6.8 | 113.7 | 2.6 | −3.5 | 11.5 | 2.07 |
| 88 (88) | 12 (12) | 6.75 | 120.6 | 2.45 | −4.3 | 12.9 | 2.06 |
| 85 (85) | 15 (15) | 6.55 | 128.6 | 2.22 | −5.9 | 14.2 | 2.03 |
| 80 (80) | 20 (20) | 5.55 | 125.1 | 1.9 | −4.9 | 15.7 | 1.88 |
| 70 (71) | 30 (29) | 4.3 | 128.3 | 1.35 | −4.5 | 15.1 | 1.57 |
| 60 (61) | 40 (39) | 3.7 | 131.6 | 1.05 | −5.8 | 15.1 | 1.74 |

As obvious from Table 3, the cooling cycle can be established at a critical pressure of CO₂ or less in a DME/CO₂ mixed refrigerant. Further, when a DME/CO₂ mixing ratio is in a nonflammable range (a molar ratio of DME of 10-12%), even if an outlet temperature of the condenser is 35° C., the compressor can work at a pressure of the compressor about 6.8 MPa, and the COP is 2.0. In addition, as a concentration of DME in a DME/CO₂ mixing ratio becomes large, a working pressure of the compressor radically decreases, and thus, release of the flame retardancy condition makes it possible to obtain an excellent solvent.

What is claimed is:

1. A refrigerant composition for a refrigerator comprising 10-40% by mole of dimethyl ether and 90-60% by mole of carbon dioxide on the basis of a total number of moles of dimethyl ether and carbon dioxide.

2. The refrigerant composition according to claim 1, wherein the refrigerator is an automotive air conditioner, a heat pump for a vending machine or an industrial/household air conditioner.

3. A method of using the refrigerant composition according to claim 1 in an automotive air conditioner, a heat pump for a vending machine, or an industrial/household air conditioner.
